(19) United States
(12) Patent Application Publication
(10) Pub. No.: US 2008/0042541 A1
(43) Pub. Date: Feb. 21, 2008

(54) MICRO-IGNITOR WITH FASTENER FOR A COMBUSTION SYSTEM

(76) Inventor: James Rhett Mayor, Ypsilanti, MI (US)

Correspondence Address: SCHOX PLC, 209 N. MAIN STREET #200, ANN ARBOR, MI, 48104, US

(21) Appl. No.: 11/465,100

(22) Filed: Aug. 16, 2006

(51) Int. Cl. H01T 13/20

(52) U.S. Cl. 313/141

(57) ABSTRACT

The micro-ignitor of the preferred embodiment includes a first electrode having a body shaped as an elongated tube and a tip that extends from the body; a second electrode having a body located substantially within and extending at least a length of the body of the first electrode and a tip that extends toward and is spaced from the tip of the first electrode; and an electrical insulator to electrically insulate between the body of the first electrode and the body of the second electrode. The first electrode and the second electrode cooperate to carry an electrical charge and to produce an ignition spark between the tip of the first electrode and the tip of the second electrode. Although the micro-ignitor can be incorporated into any suitable combustion system, the micro-ignitor is preferably incorporated into a micro combustion engine with a swing arm.

### CROSS-REFERENCE TO RELATED APPLICATIONS

This application is related to U.S. Ser. No. 11/464,924, filed on 16 Aug. 2006 and entitled “Micro-Ignitor For A Combustion System.”

### TECHNICAL FIELD

This invention relates generally to the combustion system field, and more specifically to a new and useful micro-ignitor in the combustion system field.

### BRIEF DESCRIPTION OF THE FIGURES

FIGS. 1 and 2 are perspective and cross-section views, respectively, of the micro-ignitor of the preferred embodiment.

FIG. 3 is a schematic view of the micro-ignitor in a combustion system of a first variation.

FIGS. 4 and 5 are a schematic view of the micro-ignitor in combustion systems of slightly different versions of a second variation.

### DESCRIPTION OF THE PREFERRED EMBODIMENT

The following description of the preferred embodiment of the invention is not intended to limit the invention to this preferred embodiment, but rather to enable any person skilled in the art to make and use this invention.

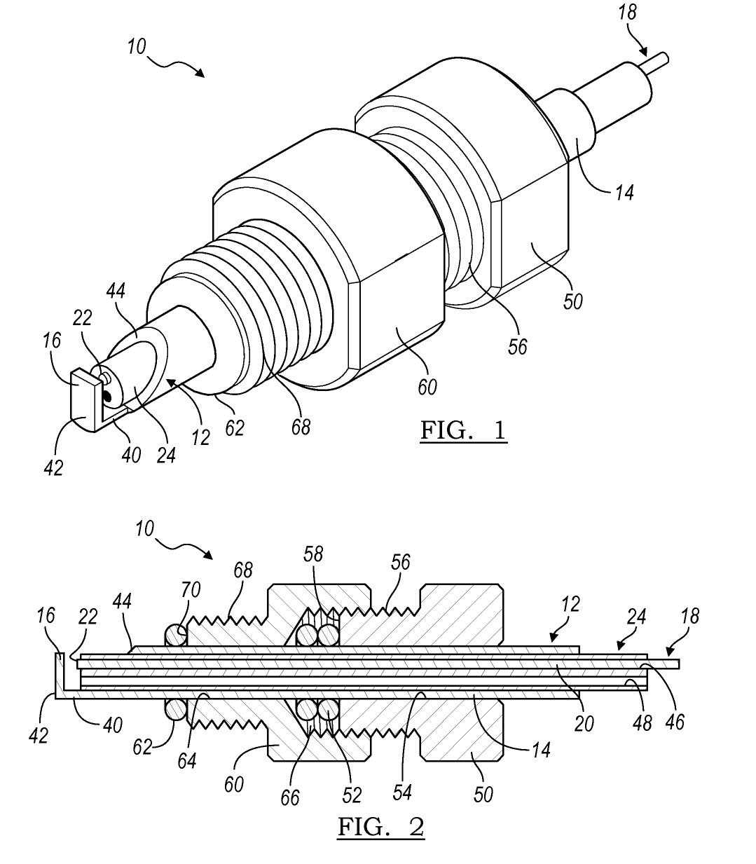

As shown in FIGS. 1 and 2, the micro-ignitor 10 of the preferred embodiment includes a first electrode 12, a second electrode 18, and an electrical insulator 24. The first electrode 12 has a body 14 shaped as an elongated tube and a tip 16 that extends from the body 14. The second electrode 18 has a body 20 located substantially within the body 14 of the first electrode 12 and extends at least a length of the body 14 of the first electrode 12. The second electrode 18 has a tip 22 that extends toward and is spaced from the tip 16 of the first electrode 12. The electrical insulator 24 is adapted to electrically insulate between the body 14 of the first electrode 12 and the body 20 of the second electrode 18. The first electrode 12 and the second electrode 18 cooperate to carry an electrical charge and to produce an ignition spark between the tip 16 of the first electrode 12 and the tip 22 of the second electrode 18.

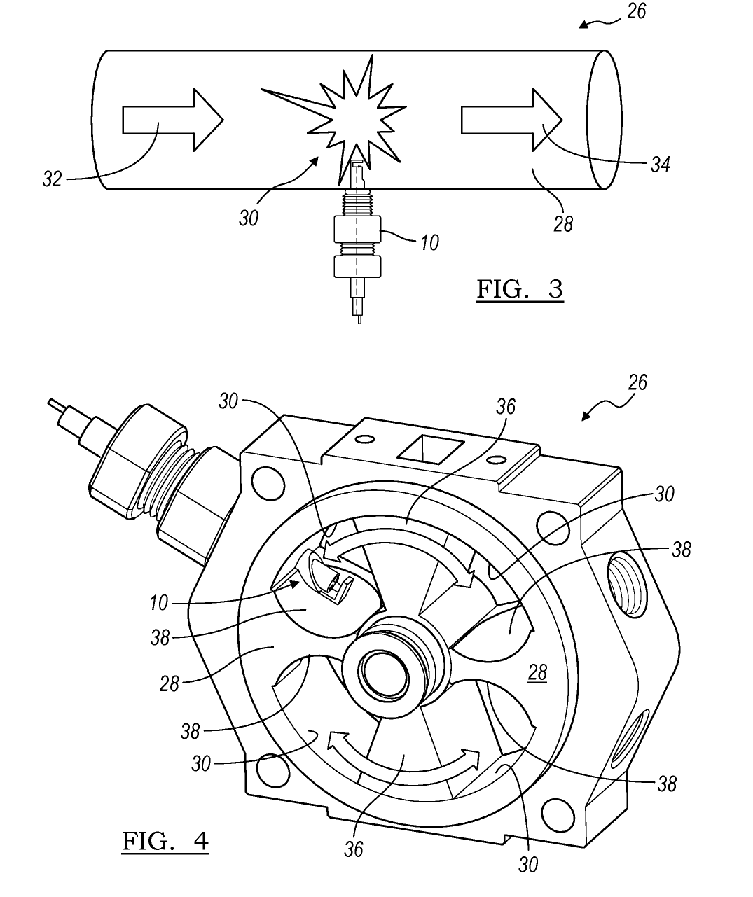

As shown in FIG. 3, the micro-ignitor 10 is preferably incorporated into a combustion system 26. The combustion system 26 of a first variation includes a housing member 28 that defines a combustion chamber 30. The micro-ignitor 10 is preferably arranged such that the tip 16 of the first electrode 12 and the tip 22 of the second electrode 18 are generally located within the combustion chamber 30 of the housing member 28. The combustion system 26 of this variation may be a tail gas burner of a vehicle, which is placed in the exhaust stream 32 of a primary internal combustion engine or any other suitable engine to reduce or convert emissions 34.

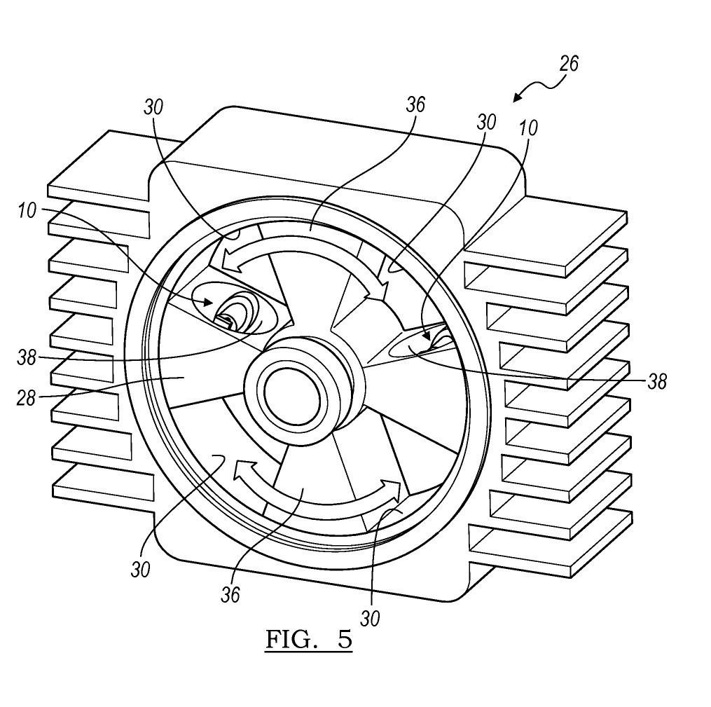

As shown in FIGS. 4 and 5, the combustion system 26 of a second variation further includes a combustion member 36 that moves within the combustion chamber 30 and converts combustion energy to mechanical energy. The combustion member 36 of the combustion system 26 is preferably a swing arm that moves in a reciprocating rotational direction within a plane in the combustion chamber 30. The combustion member 36 may, however, alternatively be a reciprocating piston, a Wankel rotor, or any other suitable combustion member that moves within the combustion chamber 30 and converts combustion energy to mechanical energy. With a swing arm as the combustion member 36, the combustion system 26 of this variation may be a micro internal combustion engine, such as the micro internal combustion swing engine described in the paper “Micro Internal Combustion Swing Engine (MICSE) for Portable Power Generation Systems” AIAA Paper 2002-0722 presented at the 40^{th} AIAA Aerospace Sciences Meeting, 14-17 Jan. 2002, Reno, Nev., which is hereby incorporated in its entirety by this reference. The micro internal combustion swing engine is, however, preferably modified such that the housing member 28 defines the combustion chamber 30 with an ignition volume 38 that preferably has a curved shape, and the tip 16 of the first electrode 12 is preferably located in the approximate center of the ignition volume 38. More preferably, as shown in FIG. 5, the ignition volume 38 has a partial spherical shape, such as a hemi-demi-sphere (or one-fourth of a sphere). The size and proportions of the micro internal combustion swing engine prevent the use of a conventional spark plug and present a challenge in the placement of an ignitor. The micro-ignitor 10 preferably solves this challenge, in part, by being placed either perpendicular to the rotational direction of the swing arm (shown in FIG. 4) or perpendicular to the plane of the swing arm (shown in FIG. 5). The micro-ignitor 10 may, however, alternatively be located along any suitable direction. Alternatively, the micro-ignitor 10 may be incorporated into any suitable device or system.

As shown in FIGS. 1 and 2 and as set forth above, the first electrode 12 of the preferred embodiment includes the body 14 shaped as the elongated tube and the tip 16 that extends from the body 14. The body 14 of the first electrode 12 functions as a ground for an electrical charge. The distal end of the body 14 may, in some variations, be connected to a ground for the combustion system 26. Preferably, the length of the body 14 is equal to or greater than 5 times the outer diameter of the body 14. More preferably, the length is equal to or greater than 10 times the outer diameter. The outer diameter is preferably less than 5 mm, and more preferably less than 3 mm. Further, the first electrode 12 is preferably free from threading, and preferably relies upon the structures described below to secure the micro-igniter 10 to the combustion system 26. As such, the first electrode 12 is liberated from high strength requirements that are required for threaded electrodes, which must be capable of withstanding torque during installation without deforming. Since the first electrode 12 is liberated from the high strength requirements, a size of the first electrode 12 may be minimized to extend into the combustion chamber 30 while minimizing spatial requirements that typical spark plugs require. These physical specifications facilitate use of the micro-ignitor 10 in micro combustion systems, such as the micro internal combustion swing engine. The first electrode 12 is preferably made from brass or any other suitable conductive and strong material.

The tip 16 of the first electrode 12 functions to facilitate an ignition spark within a predetermined volume. The tip 16 of the first electrode 12 preferably extends axially from a radial portion of the body 14 of the first electrode 12 and then preferably projects at an angle from an axis of the body 14 of the first electrode 12. The tip 16 preferably includes this extension 40 and projection 42 such that the shortest distance between the first electrode 12 and the second electrode 18—that is not electrically insulated by the electrical insulator 24—is the distance between the tip 16 of the first electrode 12 and the tip 22 of the second electrode 18. With this arrangement, the tip 16 can reliably facilitate an ignition spark within a predetermined volume.

In the preferred embodiment, the first electrode 12 also includes a taper 44 between the body 14 and the tip 16. This taper 44 functions to provide support to the extension. The taper 44 may be flat or curved so long as it does not provide a shorter distance between the first electrode 12 and the second electrode 18.

As set forth above, the second electrode 18 of the preferred embodiment includes the body 20 and the tip 22 that extends toward and is spaced from the tip 16 of the first electrode 12. The body 20 of the second electrode 18 functions as a lead for the electrical charge. The distal end of the second electrode 18 is preferably connected to an ignition system for the combustion system 26. The body 20 of the second electrode 18 is preferably located substantially within the body 14 of the first electrode 12. By “located substantially”, it is meant that at least 50% of a length of the body 20 of the second electrode 18 is located within the body 14 of the first electrode 12. More preferably, at least 80% of the length of the body 20 of the second electrode 18 is located within the body 14 of the first electrode 12. Further, the body 20 of the second electrode 18 extends at least the length of the body 14 of the first electrode 12, and preferably extends greater than the length of the body 14 of the first electrode 14. The second electrode 18 is preferably formed of tungsten, copper, platinum, or any other suitable conductive material.

As set forth above, the electrical insulator 24 of the preferred embodiment functions to electrically insulate between the body 14 of the first electrode 12 and the body 20 of the second electrode 18. The electrical insulator 24 preferably fits within the body 14 of the first electrode 12 and preferably defines a first bore 46, which functions to substantially contain the second electrode 18. In a first variation, the first bore 46 is concentric with a central axis of the electrical insulator 24. In a second variation, the first bore 46 is eccentric, or off-axis, to the central axis of the electrical insulator 24, which facilitates a reliable ignition spark within a predetermined volume. In a first variation, the electrical insulator 24 includes the first bore 46 and a second bore 48 that are both eccentric to the central axis, which may—because of the cheap availability—reduce the overall costs of the electrical insulator 24 and the micro-ignitor 10. The electrical insulator 24 is preferably formed from a ceramic material, but may alternatively be formed of any suitable electrically insulating material.

The micro-ignitor 10 of the preferred embodiment also includes a first fastener 50 and a first seal 52 that are coupled to the combustion system 26 and that cooperate to substantially prevent rotation of the first electrode 12 relative to the combustion system 26. The first fastener 50 preferably includes a central bore 54 that accepts the first electrode 12, an outer thread 56, and a seal surface 58. The first seal 52, which is preferably an o-ring, is preferably biased by the seal surface 58 of the first fastener 50 against the first electrode 12. This arrangement, which facilitates the prevention of any rotation of the first electrode 12 relative to the combustion system 26, allows the micro-ignitor 10 to be inserted into the combustion system 26, rotated to a pre-determined orientation, and then secured to the combustion system 26.

The micro-ignitor 10 of the preferred embodiment also includes a second fastener 60 and a second seal 62 that are mounted to the combustion system 26 and that cooperate to substantially prevent leakage between the second fastener 60 and the combustion system 26. The second fastener 60 preferably includes a central bore 64 that accepts the first electrode 12, an inner thread 66 that mates with the outer thread 56 of the first fastener 50, an outer thread 68 that mates with the combustion system 26, and a seal surface 70. The second seal 62, which is preferably an o-ring, is preferably biased by the seal surface 70 of the second fastener 60 against the combustion system 26. This arrangement, which facilitates the prevention of any leakage between the micro-ignitor 10 and the combustion system 26, allows the micro-ignitor 10 to be used in a combustion system with a high combustion pressure.

As a person skilled in the art will recognize from the previous detailed description and from the figures and claims, modifications and changes can be made to the preferred embodiment of the invention without departing from the scope of this invention defined in the following claims.

I claim:

1. A micro-ignitor for a combustion system, comprising:
a first electrode having a body shaped as an elongated tube, and a tip that extends from the body;
a second electrode having a body located substantially within the body of the first electrode, and a tip that extends toward the tip of the first electrode;
an electrical insulator adapted to electrically insulate between the body of the first electrode and the body of the second electrode;
wherein the first electrode, the second electrode, and the electrical insulator are arranged such that the first electrode and the second electrode cooperate to carry an electrical charge and to produce an ignition spark for the combustion system between the tip of the first electrode and the tip of the second electrode; and
a first fastener adapted to be coupled to the combustion system and to substantially prevent rotation of the first electrode relative to the combustion system.

2. The micro-ignitor of claim 1, further comprising a first seal, wherein the first fastener is adapted to bias the first seal against the first electrode and to substantially prevent rotation of the first electrode relative to the combustion system.

3. The micro-ignitor of claim 2, further comprising a second fastener adapted to be mounted to the combustion system.

4. The micro-ignitor of claim 3, further comprising a second seal, wherein the second fastener is adapted to bias the second seal against the combustion system and to substantially prevent leakage between the second fastener and the combustion system.

5. The micro-ignitor of claim 4, wherein the first fastener is further adapted to be mounted to the second fastener.

6. A combustion system, comprising:
a housing member defining a combustion chamber;
the micro-ignitor of claim 1, wherein the tip of the first electrode and the tip of the second electrode are located within the combustion chamber of the housing member; and
a first fastener adapted to be coupled to the housing member of the combustion system and to substantially prevent rotation of the first electrode relative to the combustion system.

7. The combustion system of claim 5, further comprising:
a combustion member selected from a group consisting of a reciprocating piston, a swing arm, and a Wankel rotor, wherein the combustion member is adapted to move within the combustion chamber.

8. The combustion system of claim 7, further comprising a first seal, wherein the first fastener is adapted to bias the first seal against the first electrode and to substantially prevent rotation of the first electrode relative to the housing member of the combustion system.

9. The combustion system of claim 8, further comprising a second fastener adapted to be mounted to the housing member of the combustion system.

10. The combustion system of claim 9, further comprising a second seal, wherein the second fastener is adapted to bias the second seal against the housing member of the combustion system and to substantially prevent leakage between the second fastener and the combustion system.

11. The combustion system of claim 10, wherein the first fastener is further adapted to be mounted to the second fastener.
